(19) United States
(12) Patent Application Publication
(10) Pub. No.: US 2007/0130780 A1
(43) Pub. Date: Jun. 14, 2007

(54) Dog grooming shears with comb

(76) Inventor: Eugena Hobbs, Newton, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/297,187

(22) Filed: Dec. 8, 2005

(51) Int. Cl. B26B 19/22

(52) U.S. Cl. 30/195; 30/233.5

(57) ABSTRACT

A scissor and comb combination providing means by which a groomer or barber/beautician may more efficiently and safely cut a person or animals hair, comprising a comb being formed into the rear edge of a scissor blade and the tines of the comb being formed such that the tines do not extend beyond the cutting edge of the opposite scissor blade when the scissor and comb combination are in the closed position.

### FIELD OF THE INVENTION

The present invention relates generally to a hair cutting device and more specifically to a device that combines a scissor and comb and is used to cut canine hair.

### BACKGROUND OF THE INVENTION

Using scissors and combs to cut and groom hair is a well known art. Scissors have been used since approximately 1500 B.C. and have been found in Egyptian ruins. Originally scissors consisted of two blades connected by a C-shaped spring formed as a handle of the device. This design is still used by sheep herders to shear sheep by hand today. The Romans were some of the first to use a pivoted scissor that had two blades fashioned of bronze or iron and that were secured via the use of a screw or rivet. Since the early embodiments of scissors, the design has undergone changes to incorporate features that facilitate specific tasks.

A specific task that the scissor has been adapted to is the cutting of hair. Many different refinements have been made to scissors to facilitate the cutting of hair. These damages include angling the handles, changing the finger guards, lengthening or shortening the cutting surface and changing the cutting edges of the blades. A more recent refinement to the scissors relative to the overall evolution of scissor design is the incorporation of a comb within the structure of the scissor.

An early design of a combined scissor and comb is disclosed in U.S. Pat. No. 681,740 issued to J. Sansone in 1901. The Sansone design discloses a comb attached to the back side of a scissor blade via a groove formed along the length of one of the scissor blades. A major drawback the Sansone design is that the tines of the comb extend beyond the rear edge of the scissor blade to which the comb is attached. When grooming an agitated animal, or a small child, there is a tendency for the recipient of a haircut to move their body parts with reckless disregard for the location of the scissors. Because of the greater likelihood that an animal or small child will move while having their haircut, the one cutting their hair, whether it be a groomer or a beautician/barber, often desires to have a free hand to restrain the body part they are grooming. The incorporation of a comb and a scissor allows the groomer to have a free hand to restrain the body part while styling and cutting the hair. That additional safety is negated if the instrument that the groomer is using has additional protruding tines that could cause injury to the groomed if they were to be poked by them.

Other designs have attempted to address other issues of combining a pair of scissors with a comb. U.S. Pat. No. 1,726,390 issued to J. W. Erhard et al. discloses comb that is mounted to the rear edge of a scissor blade that enables the tines or the comb to be rotated. U.S. Pat. No. 2,629,171 issued to A. L. Boegehold in 1948 discloses a comb that mounts parallel to the blade of the scissors and remains stationary as the scissors open and close. U.S. Pat. No. 3,913,866 issued to Applegate in 1975 discloses a shear and a comb combination that has the comb formed in the reversed edge of the blades and a 90° angle to the plane of the scissor blades. There are additionally numerous design patents that have issued in the United States that disclose similar items. But each of the designs disclosed have the flaw that the tines extend beyond the scissor blade. Each of the designs disclosed continue to be a safety hazard when working with a subject that is less than stationary.

### FEATURES OF THE INVENTION

A general feature of the present invention is a pair of hair scissors operably combined with a comb to facilitate and make more efficient a groomer's work.

A further feature of the present invention is the provision of a safer operable combination of comb and scissors by forming the comb in the reversed edge of a scissor blade such that the tines do not extend beyond the second scissor blades cutting edge when the scissors are in the closed position.

An additional feature of the present invention is the operable combination of scissor and comb that has a comb with multiple tines that can be varied based on the type of hair being cut.

Yet another feature of the present invention allows for the tines of the comb to extend along the length of a scissor blade.

Another feature of the present invention is a safer comb tine that has a beveled edge.

### BRIEF SUMMARY OF THE INVENTION

The present invention generally comprises an apparatus for cutting and styling hair. The device consists of a pair of scissors with a comb formed in the rear edge of one of the scissor blades. The tines of the comb are recessed into the back side of the blade and do not extend beyond the cutting edge of the opposite scissor blade when the pair of scissors are in a closed position. The number and shape of the tines and the spacing between the tines can be varied to provide the proper tension on the hair being groomed as well as to prevent tangles from developing in longer hair. The length of the comb is only restricted by the length of the scissor blade as the comb can be a single portion of the scissor blade or it can comprise the entire length of the blade.

### BRIEF DESCRIPTION OF THE DRAWINGS

FIG. 1 is a perspective view of an embodiment of the invention wherein the scissor blades are in an open position.

FIG. 2 is a perspective view of the embodiment shown in FIG. 1 wherein the scissor blades are in a closed position.

FIG. 3 is a call out of a section of a second scissor blade as depicted in FIG. 1.

FIG. 4 is a call out of a section of the closed pair of scissors of FIG. 2 wherein the second scissor blade overlays the first scissor blade.

### DETAILED DESCRIPTION OF THE PREFERRED EMBODIMENT

The present invention will be described as it applies to its preferred embodiment. It is not intended that the present invention be limited to the described embodiment. It is intended that the invention cover all modifications and alternatives, which may be included within the spirit and scope of the invention. In a preferred embodiment, the comb is incorporated into the rear edge of a single scissor blade wherein the tines of the comb do not extend beyond the cutting edge of the opposite scissor blade when it is in the closed position.

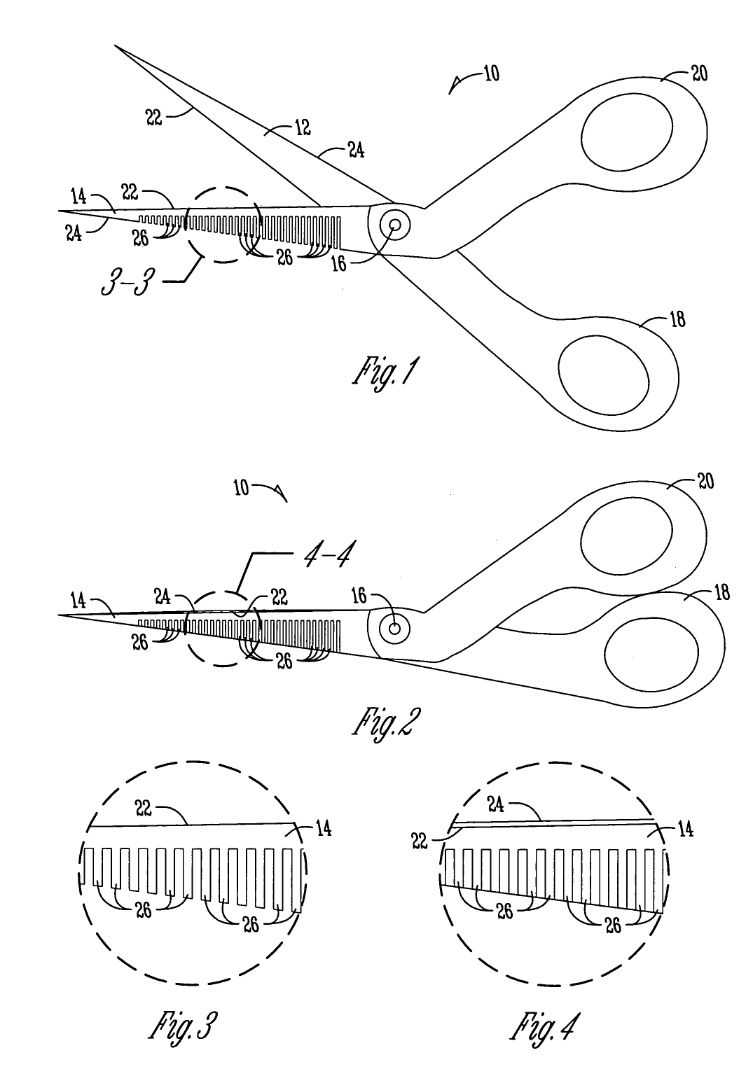

Now referring the drawings, FIG. 1 illustrates the preferred embodiment of a scissor and comb combination 10 having a first scissor blade 12, a second scissor blade 14 attached together about a pivot point or shaft 16. Each scissor blade 12, 14 is formed with a handle 18, 20 on the distal end of a scissor blade 12, 14. FIG. 1 further depicts the scissor and comb combination 10 in an open position. FIG. 2 depicts the scissor and comb combination 10 in the closed position.

The first scissor blade 12 is formed with an annular ring 18 that is adapted to receive a finger or a combination of fingers. The second scissor blade 14 is formed with an annular ring adapted to receive a thumb. The annular rings or handles 18, 20 can be shaped in any number of manners. Additionally, the handles 18, 20 can be separately attached to the individual scissor blades 12, 14. These attached handles can be made of a large selection of materials that are well known in the industry.

FIG. 1 further illustrates that each scissor blade 12, 14 has an associated rear edge 24 and a cutting edge 22. The preferred embodiment of the scissor and comb combination 10 is depicted as having scissor blades 12 and 14 essentially triangular in shape. The scissor blades 12 and 14 could be shaped in any number of manners that are well known to one skilled in the art of manufacturing and designing scissors. Other specific examples could include the rear edge 24 being formed with an arc or a combination of an arc with either straight lines that are either parallel with a cutting edge 22 or at an angle to the cutting edge 22.

FIG. 3 is a call out of the second scissor blade 14 that highlights the tines 26 of the comb portion of the scissors and comb combination 10. The length of the tines are governed by the distance between the rear edge 24 and the cutting edge 22. In the preferred embodiment the tines 26 extend to a line parallel to the line of the cutting edge 22 of the second scissor blade 14 when the scissor and comb combination 10 are in a closed position. The distance between the tines 26 and the width of the tines 26 can be adjusted to provide a best determined pattern for certain hair styles. The tines can further be modified by beveling the ends of the tines in several different manners.

FIG. 4 is a call out of the scissor and comb combination 10 wherein the scissor and blades 12 and 14 are in the closed position. FIG. 4 further depicts that the tines 26 do not extend beyond the cutting edge 22 when the scissor and comb combination 10 are in the closed position.

A general description of the present invention as well as the preferred embodiment to the present invention has been set forth. Those skilled in the art to which the present invention pertains will recognize and be able to practice additional variations in the method and systems described which fall within the teachings of this invention. Accordingly, all such modifications and additions are deemed to be within the scope of the invention which can be limited only by the claims appended hereto.

What is claimed is:

1. A scissor and comb combination for cutting hair comprising:
a scissor having a first blade and a second blade that pivot about a common point, each blade having a rear edge and a cutting edge associated with each blade;
wherein the first blade includes a first annular finger ring formed in the blade distal to the cutting edge;
wherein the second blade includes a second annular finger ring distal to the cutting edge; and
a comb with at least one tine formed in the second blade wherein the tine does not extend beyond the cutting edge of the first blade when the scissors are in a closed position.

2. The scissor and comb combination of claim 1 wherein the comb consists of multiple tines.

3. The scissor and comb combination of claim 1 wherein the comb extends along the entire length of the rear edge of the blade.

4. The scissor and comb combination of claim 1 wherein the pair of scissors is adapted to cut canine hair.

5. The scissor and comb combination of claim 1 wherein the spacing of the tines of the comb are adjusted to accommodate different hair styles.

6. The scissor and comb combination of claim 1 wherein the tine is beveled.
